(19) United States
(12) Patent Application Publication
(10) Pub. No.: US 2026/0201908 A1
(43) Pub. Date: Jul. 16, 2026

(54) LINEAR MOTION DEVICE, CONVERSION MECHANISM, CONSTRUCTION MACHINE AND RAILWAY BRAKE

(71) Applicant: NABTESCO CORPORATION, Tokyo (JP)

(72) Inventor: Yuta WANAKA, Tokyo (JP)

(21) Appl. No.: 19/135,536

(22) PCT Filed: Sep. 19, 2023
(86) PCT No.: PCT/JP2023/033971

§ 371 Date: Jun. 4, 2025

(30) Foreign Application Priority Data
Dec. 5, 2022 (JP) 2022-194482

(51) Int. Cl. F15B 15/06; B60T 13/58; B60T 13/74; B61H 13/34; E02F 9/22; F16D 65/14; F16D 121/04; F16D 125/40; F16D 125/50; F16H 25/20

(52) U.S. Cl. CPC F15B 15/06; F16H 25/20; B60T 13/588; B60T 13/745; B61H 13/34; E02F 9/2271; F16D 65/14; F16D 2121/04; F16D 2125/40; F16D 2125/50; F16H 2025/2075; F16H 2025/2087

(57) ABSTRACT

[Problem] It is desired to mitigate impacts transmitted to a linear motion mechanism, which is configured to convert rotational motion into linear motion.

[Solution] The linear motion device includes: a drive unit configured to output rotation; a linear motion mechanism configured to receive rotational motion input from the drive unit and convert the rotational motion into linear motion; a cylinder containing a fluid to which the linear motion is input from the linear motion mechanism; and an output member to which the linear motion input from the linear motion mechanism is transmitted via the fluid.

### TECHNICAL FIELD

The present invention relates to a linear motion device, a conversion mechanism, a construction machine and a railway brake.

### BACKGROUND ART

In the conventional art, there is a known device that can convert rotational motion output from an electric mechanism into linear motion and use the resulting linear motion. For example, Patent Document 1 discloses an electric linear actuator for use in a construction machine such as an excavator for the purpose of generating a propulsion force for a linear drive portion. In particular, Patent Document 1 discloses that an electric linear actuator can be used to drive a boom, an arm, a bucket of an excavator.

The electric linear actuator described in Patent Document 1 has a feed screw device constituted by a feed screw shaft and a linear motion nut, as well as an electric mechanism constituted by a rotating shaft. The feed screw device is configured such that, upon rotation of the feed screw shaft that is caused by the electric mechanism, the linear motion nut engaging with the feed screw shaft can linearly move. The electric linear actuator disclosed in Patent Document 1 uses the feed screw device to convert the rotational motion into the linear motion.

### CITATION LIST

### Patent Document

Patent Document 1: International Publication No. WO 2013/114451

### SUMMARY OF INVENTION

Mechanisms configured to convert rotational motion into linear motion, such as the feed screw device disclosed in Patent Document 1, may be affected by impacts transmitted from the object to which the linear motion is output. Specifically, such a mechanism may be used for driving a construction machine, for example, the boom, arm, or bucket of an excavator. In this case, the mechanism may be subjected to relatively large impacts. Such large impacts may damage the mechanisms configured to convert rotational motion into linear motion. Therefore, there was a need to mitigate the impacts transmitted to the mechanisms configured to convert rotational motion into linear motion.

The present invention has been made in view of such circumstances, and an object of the invention is to mitigate impacts transmitted to a linear motion mechanism configured to convert rotational motion into linear motion.

A first aspect of the present discloses provides a linear motion device including:
a drive unit configured to output rotation;
a linear motion mechanism configured to receive rotational motion input from the drive unit and convert the rotational motion into linear motion;
a cylinder containing a fluid to which the linear motion is input from the linear motion mechanism; and
an output member to which the linear motion input from the linear motion mechanism is transmitted via the fluid.

According to a second aspect of the present disclosure, in the linear motion device according to the first aspect described above, the drive unit may include: an electric mechanism; and a speed reducing unit configured to reduce rotation of the electric mechanism and transmit the reduced rotation to the linear motion mechanism.

According to a third aspect of the present disclosure, in the linear motion device according to the first or second aspect described above, an area of a surface of the linear motion mechanism that is configured to press the fluid may be different from that of a surface of the output member that is configured to be pressed by the fluid.

According to a fourth aspect of the present disclosure, in the linear motion device according to the third aspect described above, the surface of the linear motion mechanism that is configured to press the fluid may have a greater area than the surface of the output member that is configured to be pressed by the fluid.

According to a fifth aspect of the present disclosure, in the linear motion device according to each one of the first to fourth aspects described above, the cylinder may be shaped like a tube.

The linear motion mechanism may have a surface configured to press the fluid.

The output member may have a surface configured to be pressed by the fluid.

The fluid may be sealed in a space demarcated by an inner surface of the cylinder, the surface of the linear motion mechanism that is configured to press the fluid, and the surface of the output member that is configured to be pressed by the fluid.

According to a sixth aspect of the present disclosure, the linear motion device according to the fifth aspect described above may further include an accumulator including: a first chamber opening to the inner surface of the cylinder so that the first chamber is in communication with the space; and a second chamber, a volume of the second chamber being configured to change as a pressure of the first chamber changes to change a volume of the first chamber.

According to a seventh aspect of the present disclosure, the linear motion device according to each one of the first to sixth aspects described above may further include:
a housing member housing at least a rotating portion of the linear motion mechanism, the rotating portion being configured to rotate upon receiving the rotational motion input from the drive unit; and
a bearing in contact with the rotating portion and the housing member such that the rotating portion is rotatable relative to the housing member.

According to an eighth aspect of the present disclosure, in the linear motion device according to the second aspect described above, the speed reducing unit may include:
a first member having internal teeth;
a second member rotatable relative to the first member;
a crankshaft rotatably supported on the second member; and
an external gear having a through hole through which the crankshaft passes, the external gear having external teeth meshing with the internal teeth of the first member.

Here, rotation of the second member may be input into the linear motion mechanism.

According to a ninth aspect of the present disclosure, in the linear motion device according to each one of the first to eighth aspects described above, the linear motion mechanism may include a ball screw having a screw shaft and a nut.

A tenth aspect of the present disclosure provides a conversion mechanism for converting rotational motion into linear motion. The conversion mechanism includes:
a linear motion mechanism configured to convert rotational motion input thereto into linear motion;
a cylinder containing a fluid to which the linear motion is input from the linear motion mechanism; and
an output member to which the linear motion input from the linear motion mechanism is transmitted via the fluid.

An eleventh aspect of the present disclosure provides a construction machine including:
the linear motion device according to each one of the first to ninth aspects described above; and
a working portion configured to be driven by the linear motion device to move linearly.

A twelfth aspect of the present disclosure provides a railway brake including the linear motion device relating to each one of the first to ninth aspects described above.

The present invention can mitigate impacts transmitted to a linear motion mechanism configured to convert rotational motion into linear motion.

### BRIEF DESCRIPTION OF THE DRAWINGS

FIG. 1 A sectional view showing an example configuration of a linear motion device according to one embodiment.

FIG. 2 A sectional view showing a speed reducing unit relating to the embodiment.

FIG. 3 A sectional view showing the speed reducing unit relating to the embodiment.

FIG. 4 A sectional view showing an example configuration of a linear motion device relating to a first modification example.

FIG. 5 A sectional view showing an example configuration of a linear motion device relating to a second modification example.

FIG. 6 A sectional view showing an example configuration of a linear motion device relating to a third modification example.

FIG. 7 A sectional view showing an example configuration of a linear motion device relating to a fourth modification example.

FIG. 8 A sectional view showing an example configuration of the linear motion device relating to the fourth modification example.

### DESCRIPTION OF EMBODIMENTS

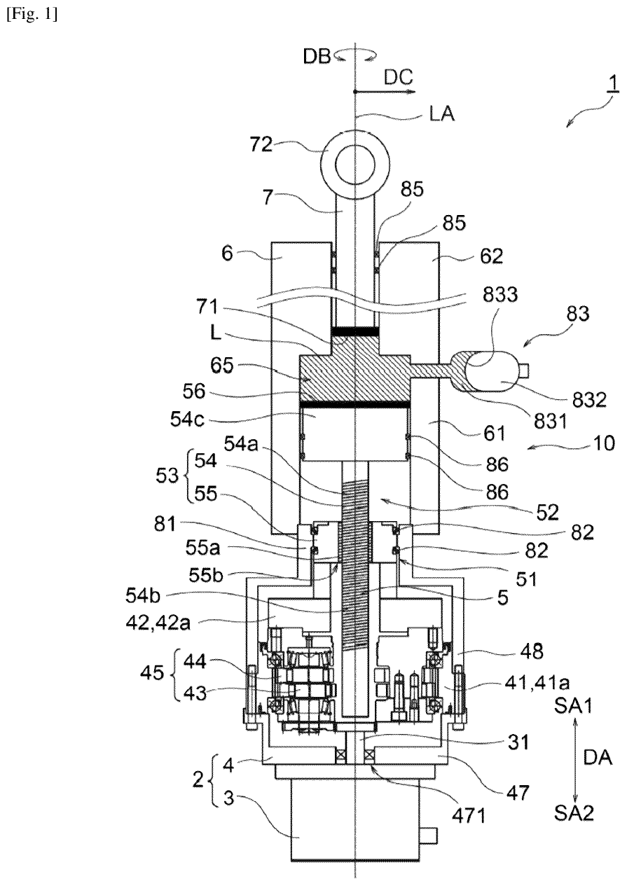

Embodiments of the present disclosure will now be described in detail with reference to the appended drawings. The following first describes a linear motion device 1 relating to an embodiment of the present disclosure. FIG. 1 is a sectional view showing an example configuration of the linear motion device 1. More specifically, FIG. 1 is a sectional view of the linear motion device 1 along a plane containing a rotation axis LA of rotation output from a drive unit 2, which will be described below.

The linear motion device 1 has a drive unit 2 that outputs rotation, a linear motion mechanism 5, a cylinder 6, and an output member 7. The linear motion mechanism 5 receives rotational motion input from the drive unit 2 and converts the rotational motion into linear motion. The cylinder 6 contains a fluid L, to which the linear motion is applied by the linear motion mechanism 5. The linear motion input from the linear motion mechanism 5 is transmitted to the output member 7 via the fluid L. The rotation axis LA extends in an axial direction DA. In the axial direction DA, a first side SA1 refers to the side where the output member 7 is positioned with respect to the linear motion mechanism 5. In the axial direction DA, a second side SA2 refers to the side where the linear motion mechanism 5 is positioned with respect to the output member 7. In addition, a circumferential direction DB refers to the direction that circles around the rotation axis LA, and a radial direction DC refers to the direction that is perpendicular to the rotation axis LA.

The following now describes the drive unit 2 more specifically. The drive unit 2 includes an electric mechanism 3 and a speed reducing unit 4 that reduces the rotation of the electric mechanism 3 and transmits the reduced rotation to the linear motion mechanism 5.

In the present embodiment, the electric mechanism 3 is a commonly used electric motor. In FIG. 1, the electric mechanism 3 is fixedly attached to a mounting member 47 of the speed reducing unit 4, which will be described below. Although not shown, the electric mechanism 3 is fixedly attached to the surface of the mounting member 47 that faces the second side SA2, by being bolted to the mounting member 47. As shown in FIG. 1, the mounting member 47 has a through hole 471 extending through the mounting member 47 in the axial direction DA. The electric mechanism 3 has a rotating shaft 31, which is inserted through the through hole 471. The rotating shaft 31 protrudes toward the first side SA1 and extends in the axial direction DA. Referring to FIG. 1, the rotation axis about which the rotating shaft 31 rotates coincides with the rotation axis LA of the rotation output from the drive unit 2.

The speed reducing unit 4 will be hereinafter described. The speed reducing unit 4 is located on the first side SA1 with respect to the electric mechanism 3 in the axial direction DA.

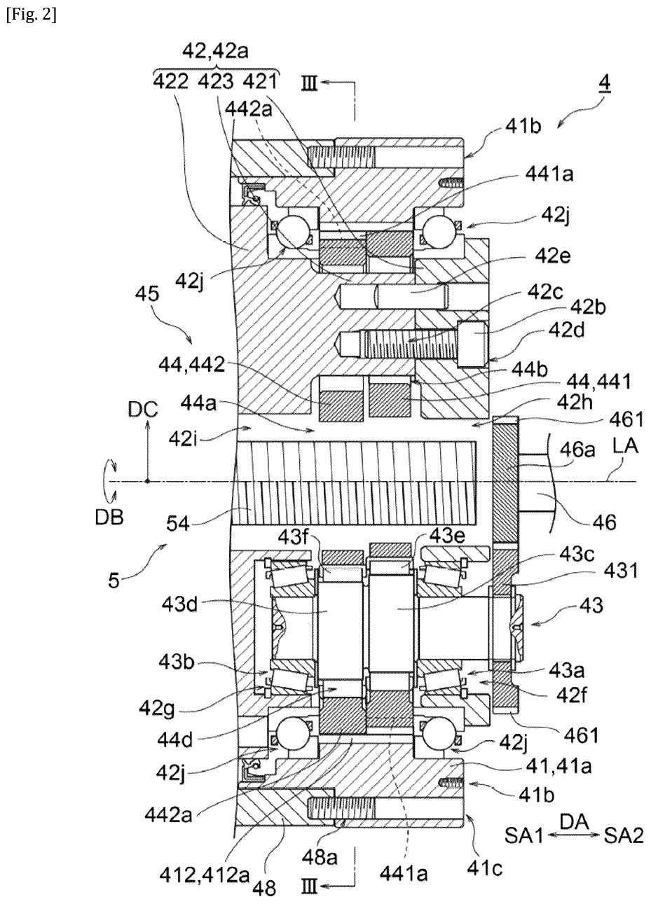

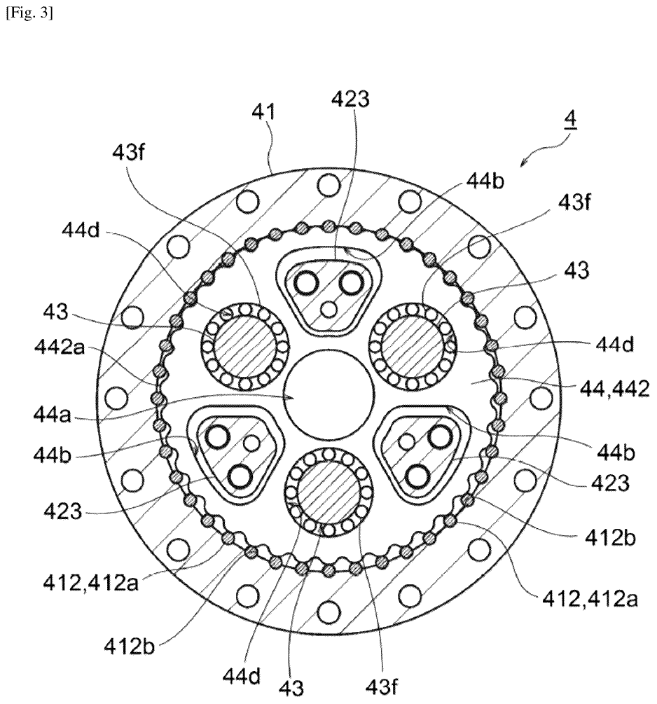

FIG. 2 is a sectional view of the speed reducing unit 4 along a plane extending through the rotation axis LA. FIG. 2 does not show the mounting member 47. FIG. 3 is a sectional view of the speed reducing unit 4 along the line III-III in FIG. 2. The speed reducing unit 4 includes a first member 41, a second member 42 rotatable relative to the first member 41, and a reduction mechanism 45 configured to reduce the rotation input from the electric mechanism 3 and cause the first and second members 41 and 42 to rotate relative to each other. The rotation of the second member 42 of the speed reducing unit 4 is input into the linear motion mechanism 5.

In the present embodiment, the first member 41 has internal teeth 412. The reduction mechanism 45 has crankshafts 43 rotatably supported by the second member 42, and external gears 44 having through holes 44d through which the crankshafts 43 pass and also having external teeth 441a and 442a. In the reduction mechanism 45, upon receiving a rotational input, the crankshafts 43 cause the external gears 44 to eccentrically oscillate. As a result of the eccentric oscillation, the external teeth 441a and 442a of the external gears 44 engage the internal teeth 412 of the first member 41, thereby causing the first and second members 41 and 42 to rotate relative to each other.

In the present embodiment, the external gears 44 have through holes 44d through which the crankshafts 43 pass. In other words, the speed reducing unit 4 relating to the present embodiment has: the first member 41 having the internal teeth 412; the second member 42 rotatable relative to the first member 41; the crankshafts 43 rotatably supported by the second member 42; and the external gears 44 having the through holes 44d through which the crankshafts 43 pass and also having the external teeth 441a and 442a meshing with the internal teeth 412 of the first member 41. The rotation of the second member 42 is input into the linear motion mechanism 5. In other words, the speed reducing unit 4 has the crankshafts 43 and external gears 44 as the reduction mechanism 45.

The reduction mechanism 45 relating to the present embodiment includes a plurality of crankshafts 43. The crankshafts 43 extend through a plurality of through holes 44d in the external gears 44. The external gears 44 each have a plurality of through holes 44d, and the crankshafts 43 respectively extend through the through holes 44d.

In the present embodiment, the speed reducing unit 4 has a casing 41a shaped like a circular cylinder, as the first member 41. The speed reducing unit 4 has, as the second member 42, a carrier 42a positioned inside the casing 41a in a radial direction DC (on the side closer to the rotation axis LA in the radial direction DC). The speed reducing unit 4 has an input shaft 46 that provides a driving force to cause the carrier 42a to rotate. The speed reducing unit 4 has the mounting member 47 having the through hole 471 where the electric mechanism 3 is fixedly provided. The mounting member 47 is shaped like a circular tube. The speed reducing unit 4 also has a third member 48 fixedly attached to the first member 41 (casing 41a). The third member 48 is shaped like a circular tube. The third member 48 is positioned on the first side SA1 in the axial direction DA with respect to the casing 41a. The casing 41a has a portion that is sandwiched between the third member 48 and the mounting member 47 in the axial direction DA. The sandwiched portion is a portion in the vicinity of the outer edge in the radial direction DC (on the side distant from the axis LA in the radial direction DC).

The casing 41a has threaded holes 41b near the outer edge in the radial direction DC (the side distant from the rotation axis LA in the radial direction DC). The threaded holes 41b extend in the axial direction DA and open toward the second side SA2. Through the threaded holes 41b, the mounting member 47 is bolted onto the casing 41a. In this manner, the mounting member 47 is fixedly attached to the casing 41a. As the mounting member 47 is fixed onto the casing 41a and the electric mechanism 3 is fixed onto the mounting member 47, the electric mechanism 3 is fixed onto the casing 41a via the mounting member 47. The casing 41a has through holes 41c near the outer edge in the radial direction DC. The through holes 41c extend in the axial direction DA and through the casing 41a. The third member 48 has threaded holes 48a extending in the axial direction DA and opening toward the second side SA2. Through the threaded holes 48a and through holes 41c, the mounting member 47 and third member 48 can be bolted onto the casing 41a. Specifically, bolts are inserted into through holes in the mounting member 47, which are not shown in FIG. 3, and into the through holes 41c in the casing 41a, and then tightened into the threaded holes 48a in the third member 48. In this manner, the mounting member 47 and third member 48 can be fastened to the casing 41a.

The inner peripheral surface of the casing 41a has the internal teeth 412. The internal teeth 412 are pin-shaped (cylindrical) teeth provided on the inner peripheral surface of the casing 41a. Specifically, the first member 41 has internal tooth pins 412a fitted into pin grooves 412b, as the internal teeth 412. The internal teeth 412 are arranged at equal intervals in the radial direction DC.

The carrier 42a is rotatably supported by a pair of main bearings 42j and rests on the casing 41a. The main bearings 42j are spaced away from each other in the axial direction. The main bearings 42j are, for example, angular contact ball bearings. The carrier 42a is positioned coaxially with the casing 41a and the rotation axis LA.

The carrier 42a includes an end plate portion 421 situated on the second side SA2 in the axial direction DA, a base plate portion 422 situated on the first side SA1 in the axial direction DA, and three columnar portions 423 that are integrally molded with the base plate portion 422 and protrude from the base plate portion 422 toward the end plate portion 421. The end plate portion 421 and base plate portion 422 are shaped like a circular plate. The columnar portions 423 shown in FIG. 3 are shaped like a column, and their section perpendicular to the axial direction DA is substantially shaped like a triangle with rounded vertices. The columnar portions 423 are arranged at equal intervals in the circumferential direction DB. The columnar portions 423 are fixed onto the end plate portion 421 by means of bolts 42b, which fasten together the columnar portions 423 and end plate portion 421 with the end surface of the columnar portions 423 being overlaid onto the end plate portion 421. In this way, a space having a predetermined width in the axial direction is formed between the base plate portion 422 and the end plate portion 421.

The columnar portions 423 each have a bolt fastening hole 42c into which the bolt 42b is tightened. The end plate portion 421 has a plurality of bolt holes 42d into which the bolts 42b are inserted. The bolts 42b are inserted into the bolt insertion hole 42d from the side opposite to the columnar portions 423 across the end plate portion 421, and tightened into the bolt fastening holes 42c in the columnar portions 423. Pins 42e for positioning the end plate portion 421 with respect to the base plate portion 422 are provided radially inside the bolts 42b. Each pin 42e spans the corresponding columnar portion 423 and the end plate portion 421. The columnar portions 423 and the base plate portion 422 may not be integrally molded. In this case, the columnar portions 423 are fastened to the base plate portion 422. Furthermore, the columnar portions 423 may be shaped in any other manner than like a column having a section perpendicular to the axial direction DA shaped like a triangle with rounded vertices. The columnar portions 423 can be shaped or configured in any manner as long as they form a space having a predetermined width in the axial direction DA between the base plate portion 422 and the end plate portion 421. The columnar portions 423 may be shaped like a circular column.

The end and base plate portions 421 and 422 each have a plurality of (for example, three in this embodiment) holes 42f and 42g, respectively, into which the crankshafts 43 of the reduction mechanism 45 are inserted. The holes 42f, 42g are arranged at equal intervals in the circumferential direction. The end and base plate portions 421 and 422 each have a through hole 42h, 42i at the center in the radial direction DC extending in the axial direction DA. The input shaft 46 is positioned coaxially with the casing 41a and the rotation axis LA.

The base end of the input shaft 46 that faces the electric mechanism 3 (faces the second side SA2 in the axial direction DA) is coupled with the rotating shaft 31 of the electric mechanism 3. As a result, the input shaft 46 can rotate together with the rotating shaft 31. The end 46a of the input shaft 46 that faces away from the electric mechanism 3 (faces the first side SA1 in the axial direction DA) is located inside the mounting member 47. The input shaft 46a has a drive gear 461 at the end 46a. The drive gear 461 has external teeth and is combined with the input shaft 46 into a single part. In the example shown in FIG. 2, a screw shaft 54 of the linear motion mechanism 5, which will be described below, is inserted through the through hole 42i in the base plate portion 422, first through holes 44a in first and second external gears 441 and 442, and the through hole 42h in the end plate portion 421. In the example shown in FIG. 1, the end of the screw shaft 54 that faces the second side SA2 in the axial direction DA is located inside the mounting member 47. As described above, in the present embodiment, the screw shaft 54 of the linear motion mechanism 5 can pass through the through hole 42i in the base plate portion 422, the first through holes 44a in the first and second external gears 441 and 442, the through hole 42h in the end plate portion 421, and the interior of the mounting member 47. This can provide a space having a certain width in which the screw shaft 54 can linearly move.

The reduction mechanism 45 causes the carrier 42a to rotate at a rotational speed that is reduced by a certain ratio from the rotational speed of the input shaft 46. The reduction mechanism 45 includes a plurality of (for example, three in this embodiment) transmission gears 431 that mesh with the drive gear 461, and a plurality of (for example, three in this embodiment) crankshafts 43 each having one end fixed to a corresponding one of the transmission gears 431. In the present embodiment, the reduction mechanism 45 has, as the external gears 44, the first and second external gears 441 and 442 that can oscillatorily rotate in coordination with the rotation of the crankshafts 43.

Since the transmission gears 431 are fixed to one end of the crankshafts 43, the rotation of the rotating shaft 31 is transmitted to the crankshafts 43 via the transmission gears 431. The crankshafts 43 may be arranged so as to extend parallel to the input shaft 46. This means that each of the crankshafts 43 rotates about an axis of rotation parallel to the rotation axis LA of the rotation output from the drive unit 2. Each crankshaft 43 is rotatably supported on the end plate portion 421 via a first crank bearing 43a. The crankshaft 43 is rotatably supported on the base plate portion 422 via a second crank bearing 43b. The first and second crank bearings 43a and 43b are, for example, tapered roller bearings.

At the center of the crankshaft 43 in the axial direction, a first eccentric portion 43c and a second eccentric portion 43d are provided eccentrically from the axis of the crankshaft 43. The first and second eccentric portions 43c, 43d are disposed adjacent to each other in the axial direction DA between the first crank bearing 43a and the second crank bearing 43b. The first eccentric portion 43c is adjacent to the first crank bearing 43a. The second eccentric portion 43d is adjacent to the second crank bearing 43b. The first and second eccentric portions 43c and 43d are out of phase with each other.

The crankshaft 43 thus configured is inserted into the holes 43f and 42g in the end and base plate portions 421 and 422. That is, the plurality of crankshafts 43 are arranged at equal intervals in the circumferential direction DB like the holes 42f and 42g.

A first roller bearing 43e is attached to the first eccentric portion 43c of the crankshaft 43. A second roller bearing 43f is attached to the second eccentric portion 43d. The first roller bearing 43e is, for example, a cylindrical roller bearing. The first and second external gears 441 and 442 can oscillatorily rotate in conjunction with the rotation of the crankshafts 43 via the roller bearings 43e and 43f.

The first and second external gears 441 and 442 are disposed in a space between the base plate portion 422 and the end plate portion 421 of the carrier 42a. The first and second external gears 441 and 442 have external teeth 441a and 442a, respectively, that mesh with the internal teeth 412 of the casing 41a. The first and second external gears 441 and 442 each have the first through hole 44a centered around the rotation axis LA, the second through holes 44b into which the columnar portions 423 are inserted, and the through holes 44d into which the crankshafts 43 are inserted. The through holes 44d receive the eccentric portions 43c and 43d of the crankshafts 43.

The first eccentric portions 43c of the crankshafts 43 and the first roller bearings 43e are inserted into the through holes 44d of the first external gear 441. The second eccentric portions 43d of the crankshafts 43 and the second roller bearings 43f are inserted into the through holes 44d of the second external gear 442. The first and second eccentric portions 43c and 43d oscillatorily rotate as the crankshafts 43 rotate, as a result of which the first and second external gears 441 and 442 oscillatorily rotate while meshing with the internal teeth 412 of the casing 41a.

The following now describes how the speed reducing unit 4 works. As the electric mechanism 3 is driven, the rotating shaft 31 and the input shaft 46 are together driven. As the input shaft 46 rotates, the transmission gears 431 may rotate via the drive gear 461. Accordingly, the crankshafts 43 may rotate together with the transmission gears 431.

Upon rotation of the crankshafts 43, the first eccentric portions 43c oscillate and the first external gear 441 resultantly rotates while meshing with the internal teeth 412. Likewise, the second eccentric portions 43d oscillate and the second external gear 442 resultantly rotates while meshing with the internal teeth 412. That is, the crankshafts 43 rotate on their axes of rotation that are parallel to the rotation axis LA of the rotation output from the drive unit 2 and also revolve around the rotation axis LA. In this manner, the rotation of the crankshafts 43 causes the first and second external gears 441 and 442 to rotate.

As the first and second external gears 441 and 442 are driven, the second member 42 (carrier 42a), which has the columnar portions 423 passing through the first and second external gears 441 and 442, is driven by the first and second external gears 441 and 442. As a result, the carrier 42a rotates relative to the casing 41a, which is fixedly attached to the electric mechanism 3 via the mounting member 47, at a rotation speed slower than that of the input shaft 46. In this manner, the speed reducing unit 4 can reduce the rotation of the electric mechanism 3.

According to the above description of the speed reducing unit 4, the reduction mechanism 45 has the crankshafts 43 and external gears 44, but the speed reducing unit 4 can be configured in any other manners. Alternatively, the reduction mechanism 45 of the speed reducing unit 4 may have a planetary gear rotatably supported by the second member 42. Upon receiving rotational input, the planetary gear may mesh with the internal teeth 412 of the first member 41, thereby causing the first and second members 41 and 42 to rotate relative to each other. In other words, the speed reducing unit 4 may be configured as a planetary-geared speed reducer.

The following now describes the linear motion mechanism 5. The linear motion mechanism 5 receives rotational motion input from the drive unit 2 and converts the rotational motion into linear motion. The linear motion mechanism 5 is positioned on the first side SA1 in the axial direction DA with respect to the speed reducing unit 4. The linear motion mechanism 5 has a rotating portion 51 configured to rotate upon receiving rotational motion input from the drive unit 2, and a linear motion portion 52 configured to linearly move as driven by the rotational motion of the rotating portion 51. The rotating portion 51 is fixed to the rotatable portion of the drive unit 2 and can thus rotate as the rotatable portion rotates. The linear motion portion 52 is prohibited from rotating in the circumferential direction DB relative to the cylinder 6. In the present embodiment, the rotating portion 51 is fixedly attached to the second member 42 (carrier 42a) of the speed reducing unit 4. Specifically, the rotating portion 51 is fixedly attached to the second member 42 via the third member 48. In this manner, the rotation of the second member 42 (carrier 42a), which rotates at a slower speed than that of the input shaft 46, is input into the rotating portion 51.

In the present embodiment, the linear motion mechanism 5 has a ball screw 53 constituted by a screw shaft 54 and a nut 55. The nut 55 of the ball screw 53 is fixedly attached to the second member 42. The nut 55 is fixed onto the end of the second member 42 that faces the first side SA1 in the axial direction DA. In the present embodiment, the nut 55 serves as the rotating portion 51 configured to rotate upon receiving rotational motion input from the drive unit 2. In the present embodiment, the screw shaft 54 serves as the linear motion portion 52 configured to linearly move when driven by the rotational motion of the rotating portion 51.

The nut 55 has a through hole 55b with internal threads 55a. The internal threads 55a are provided on the inner wall of the through hole 55b. In the present embodiment, the through hole 55b extends in the axial direction DA. The through hole 55b is positioned such that the rotation axis LA passes through the center of the through hole 55b.

The screw shaft 54 is a rod-shaped member having external threads 54a. In the present embodiment, the external threads 54a extend in the axial direction DA. The screw shaft 54 is positioned coaxially with the rotation axis LA.

The external threads 54a of the screw shaft 54 mesh with the internal threads 55a of the nut 55. As the screw shaft 54 and nut 55 are rotated relative to each other in the circumferential direction DB, the positions of the screw shaft 54 and nut 55 change relative to each other in the axial direction DA.

In the present embodiment, as the nut 55 rotates upon receiving rotation motion input from the drive unit 2, the rotational motion of the nut 55 drives the screw shaft 54, so that the screw shaft 54 linearly moves. In this manner, the linear motion mechanism 5 can convert the rotational motion into the linear motion by means of the ball screw 53 constituted by the screw shaft 54 and nut 55. As the linear motion mechanism 5 has the ball screw 53, the linear motion portion 52 moves linearly in the direction in which the through hole 55b and screw shaft 54 extend. In the present embodiment, the linear motion portion 52 linearly moves in the axial direction DA.

The linear motion mechanism 5 has a surface 56 that may press the fluid L contained in the cylinder 6, which will be described below. The surface 56 of the linear motion mechanism 5 that can press the fluid L is also referred to as the pressing surface 56. The pressing surface 56 is the surface that can press the fluid L upon input of the linear motion into the fluid L. In the present embodiment, the linear motion portion 52 of the linear motion mechanism 5 has the pressing surface 56. In the present embodiment, the pressing surface 56 is perpendicular to the direction in which the linear motion portion 52 linearly moves (the axial direction DA). In the present embodiment, the screw shaft 54, which constitutes the linear motion portion 52, is divided into a screw shaft body 54b having the external threads 54a and a pressing portion 54c provided at the end of the screw shaft body 54b that faces the first side SA1 in the axial direction DA. The pressing portion 54c has a greater dimension in the radial direction DC than the screw shaft body 54b. In the present embodiment, the surface of the pressing portion 54c that faces the first side SA1 in the axial direction DA serves as the pressing surface 56.

The following now describes the cylinder 6. The cylinder 6 contains the fluid L, to which the linear motion is applied by the linear motion mechanism 5. In the present embodiment, the cylinder 6 has a tubular shape. The cylinder 6 is positioned on the first side SA1 in the axial direction DA with respect to the linear motion mechanism 5.

The cylinder 6 houses the portion of the linear motion mechanism 5 that has the pressing surface 56. In the present embodiment, the cylinder 6 houses the pressing portion 54c of the screw shaft 54. In the present embodiment, a portion of the linear motion portion 52 protrudes into the cylinder 6 through the opening of the tubular cylinder 6 that faces the first side SA1 in the axial direction DA. The cylinder 6 thus houses the portion of the linear motion mechanism 5 that has the pressing surface 56. The portion of the cylinder 6 that houses the portion of the linear motion mechanism 5 that has the pressing surface 56 extends in the direction of the linear motion output from the linear motion mechanism 5. In the present embodiment, a portion of the cylinder 6 has a hollow that is shaped in the same manner as the pressing surface 56 in the section perpendicular to the direction in which the linear motion portion 52 linearly moves (the axial direction DA). This portion is referred to as a first portion 61 of the cylinder 6. The first portion 61 is continuous in the direction in which the linear motion portion 52 linear moves. This allows the linear motion portion 52 of the linear motion mechanism 5 to linearly move to such an extent that the portion having the pressing surface 56 does not move out of the first portion 61. In the present embodiment, the cylinder 6 extends in the axial direction DA as a whole. The cylinder 6 is arranged coaxially with the rotation axis LA.

The cylinder 6 contains the fluid L. The fluid L is contained in the cylinder 6 such that it spans the first portion 61 of the cylinder 6 and a second portion 62 of the cylinder 6, which will be described below.

The fluid L can be made from any materials as long as it can transmit the linear motion input from the linear motion mechanism 5 to the output member 7, which will be described below. The fluid L may be a liquid or gas. The fluid L is preferably a highly viscous material from the viewpoint of efficiently transmitting the linear motion input from the linear motion mechanism 5 to the output member 7, and from the viewpoint of mitigating the impact transmitted to the linear motion mechanism 5 via the fluid L, which will be described below. For example, oil is preferred as the material for the fluid L over water because oil generally has higher viscosity than water. When the fluid Lis a gas, a gas compressed at high pressure can be used as the fluid L.

The following now describes the output member 7. The output member 7 is a member to which the linear motion input from the linear motion mechanism 5 is transmitted via the fluid L. In the present embodiment, the output member 7 is positioned on the first side SA1 in the axial direction DA with respect to the cylinder 6. In the present embodiment, the output member 7 is a rod-shaped member. The output member 7 extends in the axial direction DA. The output member 7 is disposed coaxially with the rotation axis LA.

The output member 7 has a surface 71 that can be pressed by the fluid L. The surface 71 of the output member 7 that can be pressed by the fluid L is also referred to as the pressed surface 71. The pressed surface 71 is the surface that can be pressed by the fluid L upon transmission of the linear motion to the output member 7 via the fluid L. In the present embodiment, the surface of the output member 7 that faces the second side SA2 in the axial direction DA serves as the pressed surface 71.

The cylinder 6 houses the portion of the output member 7 that has the pressed surface 71. In the present embodiment, a portion of the output member 7 protrudes into the cylinder 6 through the opening of the tubular cylinder 6 that faces the second side SA2 in the axial direction DA. The cylinder 6 thus houses the portion of the output member 7 that has the pressed surface 71.

In the present embodiment, a portion of the cylinder 6 has a hollow that is shaped in the same manner as the pressed surface 71 in the section perpendicular to the direction in which the portion of the output member 7 that is housed in the cylinder 6 extends (the axial direction DA). This portion is referred to as the second portion 62 of the cylinder 6. The second portion 62 is continuous in the direction in which the portion of the output member 7 that is housed in the cylinder 6 extends. This allows the output member 7 to move linearly in the direction in which the portion of the output member 7 that is housed in the cylinder 6 extends, to such an extent that the portion of the output member 7 that has the pressed surface 71 does not move out of the second portion 62. In the present embodiment, the linear motion portion 52 of the linear motion mechanism 5 linearly moves along the same line as does the output member 7. More specifically, the linear motion portion 52 of the linear motion mechanism 5 moves linearly on the rotation axis LA, and so does the output member 7.

In the present embodiment, the output member 7 further includes a mounting portion 72 to which a working portion configured to be driven by the linear motion device 1 is attached. The mounting portion 72 is provided at the end of the output member 7 that faces away from the pressed surface 71 (the first side SA1 in the axial direction DA). The mounting portion 72 can be shaped in any manner as long as the working portion configured to be driven by the linear motion device 1 can be mounted onto the mounting portion 72. In the present embodiment, the mounting portion 72 is a rod end that can be coupled with a member. In this case, the rod end or the mounting portion 72 may be shaped like a ring.

In the present embodiment, the cylinder 6 has a tubular shape as described above. The linear motion mechanism 5 has the surface 56 (the pressing surface 56) that can press the fluid L upon input of the linear motion into the fluid L. The output member 7 has the surface 71 (the pressed surface 71) that can be pressed by the fluid L upon transmission of the linear motion via the fluid L. The fluid L is sealed in a space 65 that is delineated by the inner surface of the cylinder 6, the surface 56 of the linear motion mechanism 5 that can press the fluid L, and the surface 71 of the output member 7 that can be pressed by the fluid L.

The cylinder 6, which has a tubular shape, may be shaped like a circular or polygonal tube. If the cylinder 6 is shaped like a polygonal tube, the hollow seen in the section perpendicular to the direction in which the cylinder 6 extends may be shaped like a triangle, a rectangle, or any other polygon. The following advantageous effects can be produced if the cylinder 6 or at least the first portion 61 is shaped like a polygonal tube. The pressing surface 56 may be shaped in the same manner as the hollow in the first portion 61 in the section perpendicular to the direction in which the cylinder 6 extends. In this way, the linear motion portion 52 having the pressing surface 56 can be prevented from rotating in the circumferential direction DB relative to the cylinder 6. The following advantageous effects can be produced if the cylinder 6 or at least the second portion 62 is shaped like a polygonal tube. The pressed surface 71 may be shaped in the same manner as the hollow in the second portion 62 in the section perpendicular to the direction in which the cylinder 6 extends. In this way, the output member 7 having the pressed surface 71 can be prevented from rotating in the circumferential direction DB relative to the cylinder 6.

In the present embodiment, the pressing and pressed surfaces 56 and 71 have different areas. Specifically, the pressing surface 56 has a greater area than the pressed surface 71. In the present embodiment, the sectional area of the hollow of the first portion 61 of the cylinder 6 in the section perpendicular to the direction in which the linear motion portion 52 can linearly move (axial direction DA) is different from the sectional area of the hollow of the second portion 62 of the cylinder 6 in the direction in which the output member 7 can linearly move (axial direction DA). The sectional area of the hollow in the first portion 61 of the cylinder 6 is greater than the sectional area of the hollow in the second portion 62 of the cylinder 6.

The linear motion device 1 of the present embodiment further includes a housing member 81 accommodating at least the rotating portion 51 of the linear motion mechanism 5, which can rotate upon input of the rotational motion from the drive unit 2. The linear motion device 1 relating to the present embodiment further includes a bearing 82 in contact with the rotating portion 51 and housing member 81 such that the rotating portion 51 can rotate relative to the housing member 81.

In the present embodiment, the housing member 81 accommodates at least part of the rotating portion 51. The housing member 81 covers the rotating portion 51 of the linear motion mechanism 5 from the radial direction DC. In the present embodiment, the third member 48 is fixedly attached to the first member 41 of the speed reducing unit 4 (the casing 41a). The third member 48 extends toward the first side SA1 in the axial direction DA. The nut 55, or the rotating portion 51, of the linear motion mechanism 5 is housed within the extended portion of the third member 48. This may mean that part of the third member 48 constitutes the housing member 81.

The cylinder 6 may extend toward the second side SA2 in the axial direction DA enough to accommodate the rotating portion 51. This may mean that part of the cylinder 6 constitutes the housing member 81. The housing member 81 may be a member separate from the cylinder 6 or any of the members constituting the speed reducing unit 4.

In the present embodiment, the bearing 82 is in contact with the rotating portion 51 and the portion of the third member 48 that constitutes the housing member 81 such that the rotating portion 51 can rotate relative to the portion of the third member 48 that constitutes the housing member 81. The bearing 82 can be of any type as long as it can contact the rotating portion 51 and housing member 81 such that the rotating portion 51 can rotate relative to the housing member 81.

When it is a portion of the cylinder 6 that constitutes the housing member 81, the bearing 82 may be in contact with the rotating portion 51 and the portion of the cylinder 6 that constitutes the housing member 81 such that the rotating portion 51 can rotate relative to the portion of the cylinder 6 that constitutes the housing member 81.

In the present embodiment, the end of the cylinder 6 that faces the second side SA2 in the axial direction DA is connected with the end of the third member 48 of the speed reducing unit 4 that faces the first side SA1 in the axial direction DA. The end of the first member 41 of the speed reducing unit 4 that faces the second side SA2 in the axial direction DA is connected with the end of the mounting member 47 of the speed reducing unit 4 that faces the first side SA1 in the axial direction DA. Thus, the portion of the output member 7 having the pressed surface 71, the linear motion mechanism 5, the second member 42 (carrier 42a) of the speed reducing unit 4, and the reduction mechanism 45 are housed in the space demarcated by the cylinder 6, the first member 41 of the speed reducing unit 4, the mounting member 47 and the third member 48. This can provide protection against ambient dust for the portion of the output member 7 having the pressed surface 71, the linear motion mechanism 5, the second member 42 (carrier 42a) of the speed reducing unit 4, and the reduction mechanism 45.

The linear motion device 1 relating to the present embodiment further includes a first sealing member 85 that seals between the cylinder 6 and the portion of the output member 7 that spans between the mounting portion 72 and the pressed surface 71. The pressed surface 71 of the output member 7 and the like can be more reliably protected. The linear motion device 1 relating to the present embodiment further includes a second sealing member 86 that seals between the cylinder 6 and the portion of the linear motion portion 52 that spans between the drive unit 2 and the pressing surface 56. This can lower the risk of blending of the fluid L with the lubricating oil used for the linear motion mechanism 5 and speed reducing unit 4.

The linear motion device 1 relating to the present embodiment further includes an accumulator 83. The accumulator 83 has a first chamber 831 and a second chamber 832. The first chamber 831 opens to the inner surface of the cylinder 6 to lead to the space 65, and the volume of the second chamber 832 changes as the pressure in the first chamber 831 changes, in order to change the volume of the first chamber 831. In the present embodiment, the accumulator 83 is shaped like a container that opens to the inner surface of the cylinder 6 to lead to the space 65. Inside the accumulator 83, the first and second chambers 831 and 832 are defined. The first chamber 831 communicates with the space 65 through the opening. This means that the fluid L can flow into the first chamber 831. The second chamber 832 is separated from the first chamber 831 by means of a diaphragm 833. The diaphragm 833 deforms as the difference in pressure between the first and second chambers 831 and 832 changes. The second chamber 832 is filled with a gas, for example, nitrogen.

When the pressure in the space 65 and first chamber 831 becomes higher than the pressure in the second chamber 832, the diaphragm 833 deforms due to the difference in pressure between the first and second chambers 831 and 832, and the volume of the second chamber 832 decreases. The reduction in the volume of the second chamber 832 is translated into an increase in the volume of the first chamber 831. When the pressure in the space 65 and first chamber 831 becomes lower than the pressure in the second chamber 832, the diaphragm 833 deforms due to the difference in pressure between the first and second chambers 831 and 832, and the volume of the second chamber 832 increases. The increase in the volume of the second chamber 832 results in reduction in the volume of the first chamber 831. The volume of the second chamber 832 changes as the pressure in the first chamber 831 changes, as a result of which the volume of the first chamber 831 changes. As described above, in the accumulator 83, the volume of the first chamber 831, to which the fluid L can flow, increases if the pressure in the space 65 is high, and the volume of the first chamber 831, into which the fluid L can flow, decreases if the pressure in the space 65 is low.

The following describes how the linear motion device 1 relating to the present embodiment works. The following first describes how the linear motion device 1 works in order to drive the working portion. The working portion is, for example, a construction machine such as an excavator and a railway brake. In order to use the linear motion device 1 to drive the working portion, the working portion is attached to the mounting portion 72 of the output member 7 in advance. The drive unit 2 then outputs rotation. When the drive unit 2 is constituted by the electric mechanism 3 and speed reducing unit 4, the rotation output from the drive unit 2 is the rotation output from the electric mechanism 3 and then reduced by the speed reducing unit 4. The drive unit 2 thus inputs rotational motion into the linear motion mechanism 5. The linear motion mechanism 5 receives the rotational motion input from the drive unit 2 and converts the rotational motion into linear motion. In the present embodiment, the rotational motion is input from the drive unit 2 to the rotating portion 51, thereby causing the rotating portion 51 to rotate. The rotational motion of the rotating portion 51 drives the linear motion portion 52, so that the linear motion portion 52 linear moves. In this manner, the rotation motion is converted into the linear motion. This causes the portion of the linear motion portion 52 that has the pressing surface 56 to linearly moves inside the cylinder 6, more specifically, inside the first portion 61 of the cylinder 6. As a result, the liquid L contained in the cylinder 6 is pressed by the pressing surface 56. In the present embodiment, the liquid L is pressed by the pressing surface 56 toward the first side SA1 in the axial direction DA. As pressed by the pressing surface 56, the liquid L presses the portion of the output member 7 that has the pressed surface 71. In the present embodiment, the liquid L presses the portion of the output member 7 that has the pressed surface 71 toward the first side SA1 in the axial direction DA. As pressed by the liquid L, the output member 7 linear moves in the direction in which the portion of the output member 7 that is housed in the cylinder 6 extends. In the above-described manner, the working portion, which is attached to the mounting portion 72 of the output member 7, can linearly move together with the output member 7.

The following describes how to mitigate the impact transmitted to the linear motion mechanism 5 when the linear motion device 1 is affected by an impact from the object to which the linear motion device 1 outputs the linear motion. More specifically, the following description is related to how to mitigate the impact transmitted to the linear motion mechanism 5 when the linear motion device 1 is affected by an impact from the working portion attached to the mounting portion 72 of the output member 7. When the linear motion device 1 is impacted by the working portion attached to the mounting portion 72 of the output member 7, the output member 7 can be pushed into the cylinder 6 toward the linear motion mechanism 5 (toward the second side SA2 in the axial direction DA). The output member 7 is then expected to move toward the second side SA2 in the axial direction DA, thereby pressing the fluid L.

Here, the linear motion device 1 relating to the present embodiment includes: the linear motion mechanism 5 configured to receive the rotational motion input from the drive unit 2 and convert the rotational motion into linear motion; the cylinder 6 containing the fluid L to which the linear motion is applied from the linear motion mechanism 5; and the output member 7 to which the linear motion input from the linear motion mechanism 5 is transmitted via the fluid L. This means that the fluid L is positioned between the output member 7 and the linear motion mechanism 5. As the fluid L is positioned between the output member 7 and the linear motion mechanism 5, the fluid L can work to mitigate the impact transmitted from the output member 7 to the linear motion mechanism 5. Specifically, the fluid L can mitigate the impact transmitted from the output member 7 to the linear motion mechanism 5 when a temporary and strong impact is applied to the working portion attached to the output member 7. According to the linear motion device 1 relating to the present embodiment, the impact can be mitigated before transmitted to the linear motion mechanism 5.

In the present embodiment, the drive unit 2 is located opposite the output member 7 and cylinder 6 with the linear motion mechanism 5 being positioned therebetween. According to the linear motion device 1 relating to the present embodiment, the fluid L can mitigate the impact transmitted from the output member 7 to the linear motion mechanism 5, thereby preventing a strong impact from being transmitted from the output member 7 to the drive unit 2.

In the present embodiment, the drive unit 2 includes the electric mechanism 3, and the speed reducing unit 4 that reduces the rotation of the electric mechanism 3 and transmits the reduced rotation to the linear motion mechanism 5. Since the drive unit 2 includes the speed reducing unit 4 as well as the electric mechanism 3, the following advantageous effects are produced. Unless the drive unit 2 has the speed reducing unit 4, the electric mechanism 3 would need to be enlarged in order to allow the drive unit 2 to output a large torque. Since the drive unit 2 has the speed reducing unit 4 in the present embodiment, the drive unit 2 can output a large torque while avoiding an increase in size of the electric mechanism 3. According to the linear motion device 1 relating to the present embodiment, when the drive unit 2 has the electric mechanism 3 and speed reducing unit 4, strong impacts can be prevented from being transmitted from the output member 7 to the electric mechanism 3 and speed reducing unit 4 since the fluid L can mitigate the impact transmitted from the output member 7 to the linear motion mechanism 5. The speed reducing unit 4 can be reliably protected against impacts.

In the present embodiment, the speed reducing unit 4 has: the first member 41 having the internal teeth 412, the second member 42 rotatable relative to the first member 41, the crankshafts 43 rotatably supported by the second member 42, and the external gears 44 having the through holes 44d through which the crankshafts 43 pass and also having the external teeth 441a and 442a meshing with the internal teeth 412 of the first member 41, as described above. According to the linear motion device 1 relating to the present embodiment, the speed reducing unit 4 configured in this manner can be reliably protected against impacts.

In the present embodiment, the fluid L is sealed in the space 65 demarcated by the inner surface of the cylinder 6, the surface 56 of the linear motion mechanism 5 that is configured to press the fluid L, and the surface 71 of the output member 7 that is configured to be pressed by the fluid L. In this manner, when the linear motion device 1 is used to drive the working portion, the force exerted by the pressing surface 56 to press the fluid L can be efficiently transmitted to the output member 7 via the fluid L.

In the present embodiment, the area of the surface 56 of the linear motion mechanism 5 that is configured to press the fluid L (the pressing surface 56) is different from that of the surface 71 of the output member 7 that is configured to be pressed by the fluid L (the pressed surface 71). In the present embodiment, the sectional area of the hollow in the first portion 61 of the cylinder 6 in the section perpendicular to the direction in which the linear motion portion 52 linearly moves (the axial direction DA) is different from the sectional area of the hollow in the second portion 62 of the cylinder 6 in the direction in which the output member 7 can linearly move (the axial direction DA). In this manner, the ratio of the distance the pressed surface 71 moves to the distance the pressing surface 56 moves can be adjusted according to Pascal's principle. For example, if the pressing surface 56 has a greater area than the pressed surface 71, the ratio of the distance the pressed surface 71 moves to the distance the pressing surface 56 moves can be greater than one. Alternatively, the surface 56 of the linear motion mechanism 5 that is configured to press the fluid L (the pressing surface 56) may have a smaller area than the surface 71 of the output member 7 that is configured to be pressed by the fluid L (the pressed surface 71). If the pressing surface 56 has a smaller area than the pressed surface 71, the ratio of the distance the pressed surface 71 moves to the distance the pressing surface 56 moves can be less than one. Similarly, the ratio of the speed at which the pressed surface 71 moves to the speed at which the pressing surface 56 moves can be adjusted.

The following additionally describes the advantageous effects produced by the fact that the pressing and pressed surfaces 56 and 71 have different areas. As a comparison, consider a hypothetical case where the pressing and pressed surfaces 56 and 71 in the linear motion device 1have equal areas. In this case, it is necessary to control the linear motion portion 52 to move at the same speed and the same distance as in linear motion that is desired to be output from the linear motion device 1. For example, if the linear motion mechanism 5 has the ball screw 53, it is necessary to adjust the crest-to-crest thread pitch of the external threads 54a of the screw shaft 54 and that of the internal threads 55a of the nut 55 and also to adjust the length of the screw shaft 54 in the direction in which the linear motion portion 52 can linearly move, so that the linear motion portion 52 can move at the desired speed and the desired distance. In the linear motion device 1 relating to the present embodiment, however, the pressing and pressed surfaces 56 and 71 have different areas. Therefore, the speed of and distance moved in the linear motion output from the linear motion mechanism 5 can be changed by the action of the fluid L contained in the cylinder 6 before the linear motion is transmitted to the output member 7. As a result, the linear motion mechanism 5 used in the linear motion device 1 can be selected with greater flexibility.

In the present embodiment, the surface 56 of the linear motion mechanism 5 that is configured to press the fluid L (the pressing surface 56) has a greater area than the surface 71 of the output member 7 that is configured to be pressed by the fluid L (the pressed surface 71). In the present embodiment, the sectional area of the hollow in the first portion 61 of the cylinder 6 in the section perpendicular to the direction in which the linear motion portion 52 can move linearly (axial direction DA) is greater than the sectional area of the hollow in the second portion 62 of the cylinder 6 in the direction in which the output member 7 can move linearly (axial direction DA). Therefore, according to Pascal's law, the ratio of the distance the pressed surface 71 moves to the distance the pressing surface 56 moves can be greater than one. In order to cause the output member 7 to move linearly in a desired manner, it is required to control the linear motion portion 52 of the linear motion mechanism 5 to move linearly at a speed lower than a required speed for the linear motion of the output member 7 and a distance less than a required distance for the linear motion of the output member 7. In this manner, the linear motion portion 52 is only required to move linearly at a relatively low speed and a relatively short distance even if the output member 7 is required to move linearly at a relatively high speed and a relatively long distance. As a consequence, the linear motion mechanism 5 can accomplish a small size while the output member 7 is capable of moving linearly in a desired manner.

In the present embodiment, the drive unit 2 has the speed reducing unit 4. Additionally, the pressing surface 56 has a greater area than the pressed surface 71. Therefore, the rotational motion output from the electric mechanism 3 of the drive unit 2 is reduced by the speed reducing unit 4, converted into the linear motion by the linear motion mechanism 5, increased by the fluid L contained in the cylinder 6 and then finally transmitted to the output member 7. As the linear motion device 1 is configured in the above-described manner, the output member 7 can move linearly at a relatively high speed and a relatively long distance while the electric mechanism 3 and linear motion mechanism 5 have a small size. In addition, less electric power needs to be input into the electric mechanism 3 in order to control the output member 7 to move linearly at a desired speed and a desired distance.

The linear motion device 1 relating to the present embodiment further includes the housing member 81 and bearing 82. The housing 81 houses at least the rotating portion 51 of the linear motion mechanism 5, and the bearing 82 is in contact with the rotating portion 51 and housing member 81 such that the rotating portion 51 can rotate relative to the housing member 81. In this way, the housing member 81 can support the rotating portion 51 via the bearing 82 while allowing the rotating portion 51 to rotate. When an impact is transmitted from the output member 7 to the linear motion mechanism 5, the impact can be released to the housing member 81 via the bearing 82. This can result in improving resistance of the linear motion mechanism 5 against impacts. For example, the components constituting the linear motion mechanism 5, such as the rotating portion 51 and linear motion portion 52, can be prevented from being deformed by impacts.

The linear motion device 1 relating to the present embodiment further includes the accumulator 83. The accumulator 83 has the first chamber 831 opening to the inner surface of the cylinder 6 so that the first chamber 831 is in communication with the space 65, and the second chamber 832. The volume of the second chamber 832 is configured to change as the pressure in the first chamber 831 changes, to change the volume of the first chamber 831. The accumulator 83 works as follows. The volume of the first chamber 831, into which the fluid L can flow, increases when the pressure in the space 65 is high, but decreases when the pressure in the space 65 is low. The accumulator 83 can thus prevent a sudden increase or decrease in the pressure in the space 65. The pressure in the space 65 may radically rise if impacts are applied to the output member 7 and the output member 7 is pushed into the interior of the cylinder 6.

The linear motion device 1 relating to the present embodiment may further include a force sensor for measuring the force applied to the linear motion portion 52 of the linear motion mechanism 5 and to the output member 7, and a position sensor for measuring how much the linear motion portion 52 of the linear motion mechanism 5 and the output member 7 have moved. Having the force or position sensor, the linear motion device 1 can detect whether an external impact is applied to the linear motion portion 52 or the output member 7. As soon as it is detected that an external impact is applied to the linear motion portion 52 or output member 7, the drive unit 2 can output rotational motion to the linear motion mechanism 5, thereby exerting a force against the impact. This can provide protection for the linear motion mechanism 5 or drive unit 2.

The part of the linear motion device 1 relating to the present embodiment described above that has the linear motion mechanism 5, cylinder 6, and output member 7 may be referred to as a conversion mechanism 10. The conversion mechanism 10 is configured to convert rotational motion into linear motion. The conversion mechanism 10 includes: the linear motion mechanism 5 configured to receive rotational motion input thereto into linear motion; the cylinder 6 containing the fluid L to which the linear motion is input from the linear motion mechanism 5; and the output member 7 to which the linear motion input from the linear motion mechanism 5 is transmitted via the fluid L. According to the conversion mechanism 10, the fluid L can mitigate the impact transmitted from the output member 7 to the linear motion mechanism 5.

The linear motion device 1 relating to the present embodiment described above can be used in construction machines. In this case, the linear motion device 1 and the working portion configured to be directly driven by the linear motion device 1 may constitute a construction machine. The working portion is attached to the mounting portion 72 of the output member 7, for example. The construction machine may be an excavator, for example. If the construction machine is an excavator, the working portion is, for example, the boom, arm, bucket of the excavator. As the construction machine has the linear motion device 1 relating to the present embodiment, the fluid L can mitigate the impact transmitted from the working portion to the linear motion mechanism 5 while the linear motion device 1 can drive the working portion so that the working portion can move linearly.

The linear motion device 1 relating to the present embodiment described above may be used for railway brakes. In this case, the linear motion device 1 can constitute a railway brake. As the railway brake has the linear motion device 1 relating to the present embodiment, the fluid L can mitigate the impact transmitted from the working portion of the railway brake to the linear motion mechanism 5 while the linear motion device 1 can drive the working portion of the railway brake so that the working portion can move linearly.

While the foregoing has described the embodiment through specific examples, these specific examples are not intended to limit the embodiment. The foregoing embodiment can be implemented in various other specific forms and is susceptible to omission, replacement, modification and addition of various elements thereof within the purport of the invention.

With reference to the appended drawings, the following describes modification examples. In the following description and the drawings used therein, parts that can be configured in a similar manner to those in the foregoing specific examples are denoted by the same reference signs as those in the foregoing specific examples and are not described again.

### First Modification Example

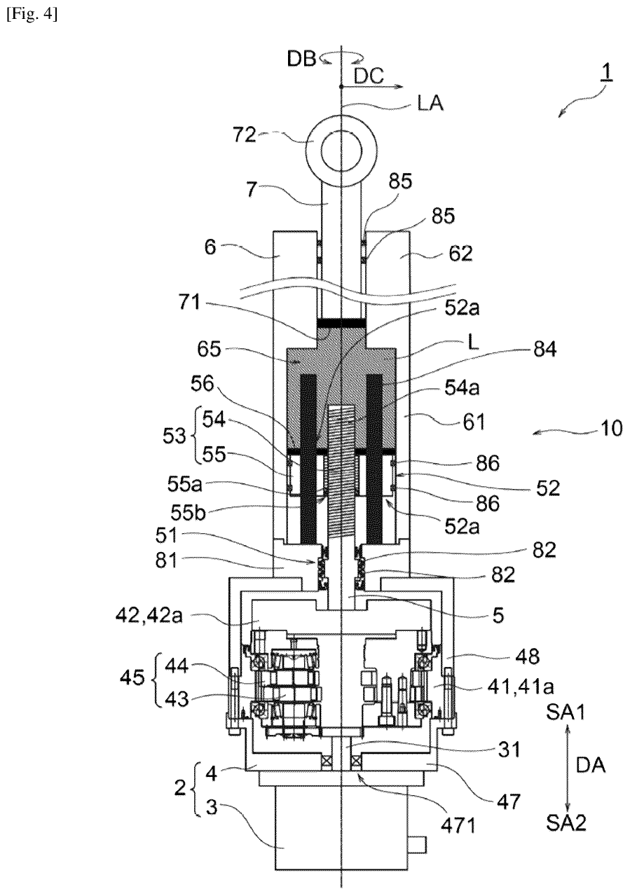

According to the embodiment described above, in the linear motion mechanism 5 having the ball screw 53, the nut 55 serves as the rotating portion 51, and the screw shaft 54 serves as the linear motion portion 52. However, the linear motion mechanism 5 may be configured in any other manners. FIG. 4 is a sectional view showing a linear motion device 1 relating to a first modification example. Specifically, FIG. 4 is a sectional view showing the linear motion device 1 along a plane passing through the rotation axis LA of the rotation output from the drive unit 2.

According to the first modification example, the screw shaft 54 of the ball screw 53 serves as the rotating portion 51, and the nut 55 serves as the linear motion portion 52. According to the first modification example, the screw shaft 54 is fixedly attached to the second member 42 of the speed reducing unit 4 (carrier 42a). The screw shaft 54 thus serves as the rotating portion 51, which can rotate upon input of rotation from the second member 42. According to the first modification example, the nut 55 is not fixed to the second member 42 (carrier 42a). The nut 55 serves as the linear motion portion 52, which can move linearly when driven by the rotational motion of the screw shaft 54 serving as the rotating portion 51.

According to the first modification example, the surface of the nut 55 that faces the first side SA1 in the axial direction DA serves as the pressing surface 56, which is configured to press the fluid L contained in the cylinder 6. In the linear motion mechanism 5 relating to the first modification example, the rotational motion of the screw shaft 54 can drive the nut 55 so that the nut 55 moves linearly. As a result, the pressing surface 56 of the nut 55 presses the fluid L.

According to the first modification example, the housing member 81 accommodates the screw shaft 54 serving as the rotating portion 51. According to the first modification example, the bearing 82 is in contact with the screw shaft 54 and housing member 81 such that the screw shaft 54 serving as the rotating portion 51 can rotate relative to the housing member 81. The bearing 82 is in contact with the portion of the screw shaft 54 that does not have the external threads 54a. According to the first modification example, the housing member 81 is a member separate from the cylinder 6 or any of the members constituting the speed reducing unit 4. The housing member 81 is connected to the cylinder 6 on the first side SA1 in the axial direction DA and to the second member 42 (carrier 42a) on the second side SA2 in the axial direction DA. The space inside the linear motion device 1 is thus demarcated by the housing member 81, the cylinder 6, and the second member 42 and mounting member 47 of the speed reducing unit 4.

The linear motion device 1 relating to the first modification example further includes a rotation restricting member 84 configured to restrict rotation of the linear motion portion 52 relative to the cylinder 6. The rotation restraining portion 61 is a rod-shaped member extending in the direction in which the linear motion portion 52 linearly moves, inside the first portion 61 of the cylinder 6. The linear motion device 1 relating to the first modification example has two rotation restricting members 84. According to the first modification example, the linear motion portion 52 has through holes 52a extending in the direction in which the linear motion portion 52 linearly moves. The rotation restricting members 84 pass through the through holes 52a. The rotation restricting members 84 are fixedly attached to the housing member 81. These rotation restricting members 84 only allow the linear motion portion 52 to move linearly.

Although not shown, the linear motion mechanism 5 may have a sealing portion preventing the fluid L from flowing into the through hole 55b of the nut 55. For example, the sealing portion can prevent the fluid L from flowing between the nut 55 and the screw shaft 54. The sealing portion is attached to the nut 55, which constitutes the linear motion portion 52, and can linearly move together with the nut 55.

### Second Modification Example

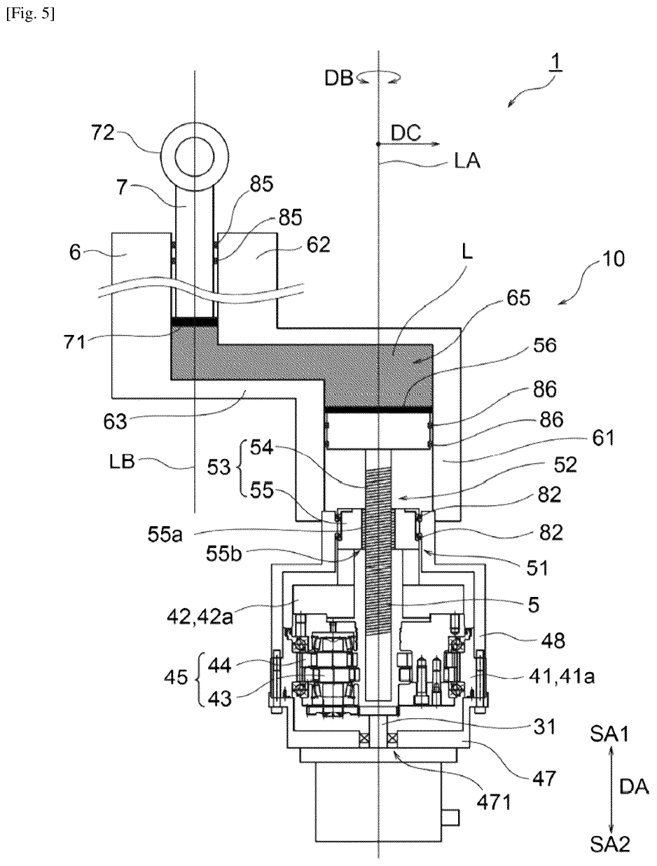

According to the embodiment and modification example described above, the linear motion portion 52 of the linear motion mechanism 5 linearly moves along the same line as does the output member 7. However, the linear motion device 1 may be configured in any other manners. FIG. 5 is a sectional view showing a linear motion device 1 relating to the first modification example. More specifically, FIG. 5 is a sectional view of the linear motion device 1 along a plane passing through the rotation axis LA of the rotation output from the drive unit 2 and the axis LB of the output member 7.

According to the second modification example, the first portion 61 of the cylinder 6 is coaxial with the rotation axis LA. Therefore, the linear motion portion 52 linearly moves on the rotation axis LA. On the other hand, the second portion 62 of the cylinder 6 is not coaxial with the rotation axis LA. Therefore, the axis LB of the output member 7 coincides with neither the rotation axis LA of the rotation output from the drive unit 2 nor the axis of the linear motion portion 52.

According to the second modification example, the linear motion portion 52 linearly moves on the rotation axis LA. The output member 7 linearly moves on the axis LB, which does not coincide with the rotation axis LA. According to the second modification example, the linear motion portion 52 and output member 7 linearly move on different lines.

According to the second modification example, the first and second portions 61 and 62 may extend in parallel or non-parallel directions. The linear motion portion 52 and output member 7 may linearly move on parallel or non-parallel lines.

According to the second modification example, the cylinder 6 has the first portion 61 through which the portion of the linear motion portion 52 that has the pressing surface 56 can move, and the second portion 62 through which the portion of the output member 7 that has the pressed surface 71 can move. In addition, the cylinder 6 has a third portion 63 that extends in a direction that is non-parallel to the directions in which the first and second portions 61 and 62 extend, and that connects the first and second portions 61 and 62. The fluid L is contained in the cylinder 6. Specifically, the fluid L fills the third portion 63 and spans the first and second portions 61 and 62. In the second modification example, as in the embodiment and modification example described above, the pressing surface 56 of the linear motion portion 52 presses the fluid L, which then presses the pressed surface 71 of the output member 7. This results in causing the output member 7 to move linearly.

### Third Modification Example

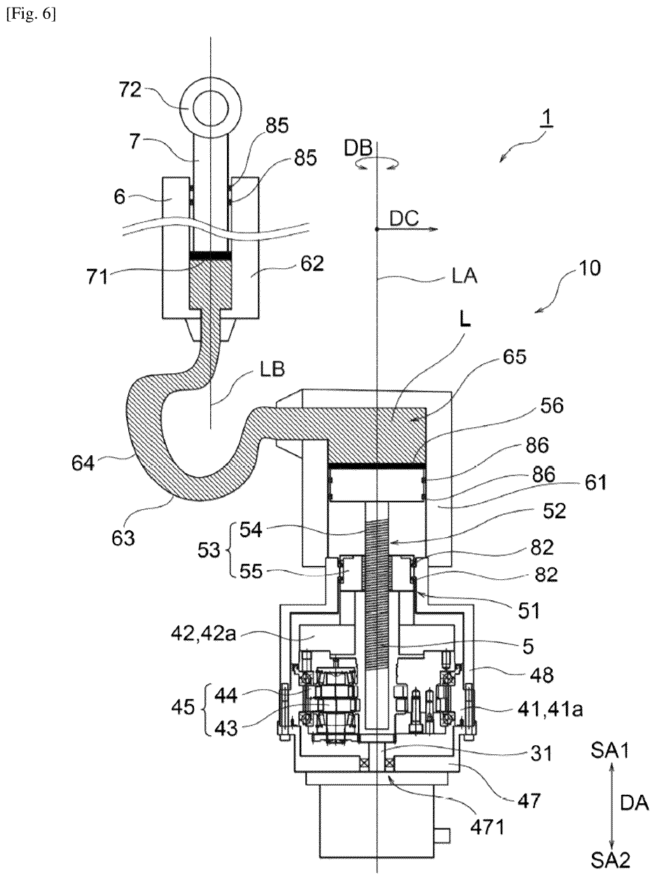

The third portion 63 of the cylinder 6, which connects the first and second portions 61 and 62, may include a portion formed from a flexible material. FIG. 6 is a sectional view showing a linear motion device 1 relating to a third modification example. More specifically, FIG. 6 is a sectional view of the linear motion device 1 along a plane passing through the rotation axis LA of the rotation output from the drive unit 2 and the axis LB of the output member 7.

According to the third modification example, the third portion 63 of the cylinder 6 has a deformable portion 64 formed from a flexible material. The deformable portion 64 can be made of any material as long as the deformable portion 64 is flexible and can transmit the linear motion input from the linear motion mechanism 5 to the output member 7. The deformable portion 64 is a rubber hose, for example. In the third modification example, the fluid L is contained in the cylinder 6, such that the fluid L fills the third portion 63 and spans the first and second portions 61 and 62. In the third modification example, as in the embodiment and modification examples described above, the pressing surface 56 of the linear motion portion 52 presses the fluid L, which then presses the pressed surface 71 of the output member 7. This results in causing the output member 7 to move linearly.

According to the linear motion device 1 relating to the third modification example, the positions of the output member 7, linear motion mechanism 5 and drive unit 2 relative to each other can change freely because the deformable portion 64 deforms.

### Fourth Modification Example

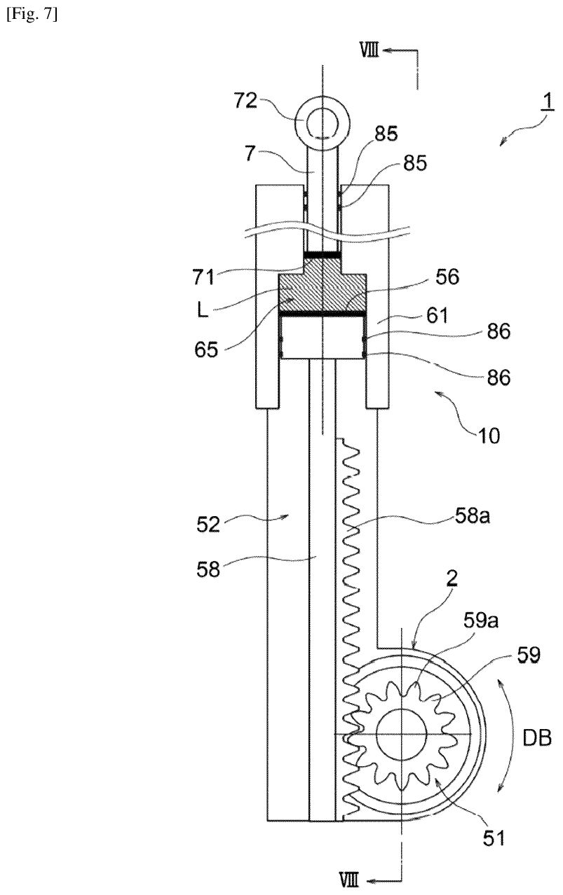

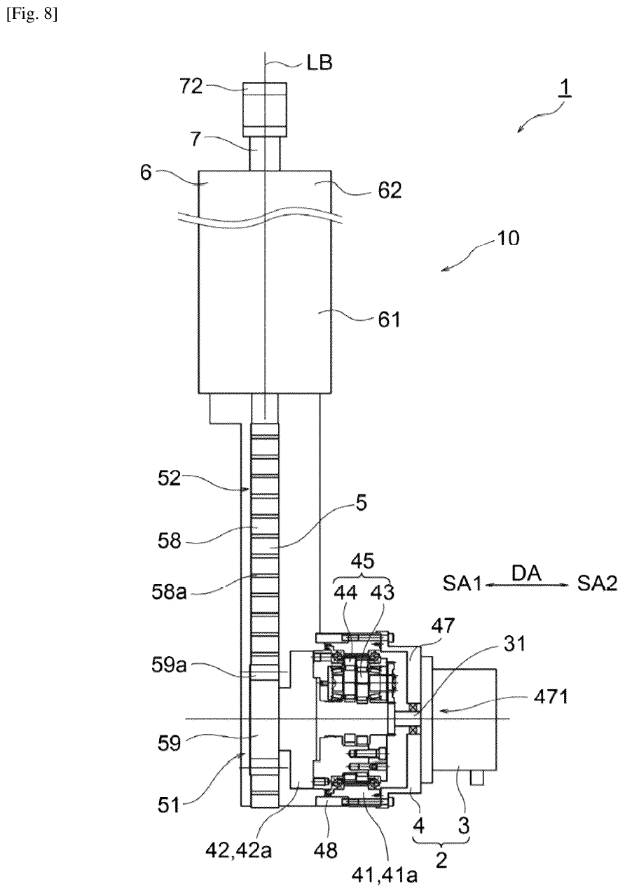

According to the embodiment and modification examples described above, the linear motion mechanism 5 has the ball screw 53. However, the linear motion mechanism 5 may be configured in any other manners. FIGS. 7 and 8 are sectional views showing a linear motion device 1 relating to a fourth modification example.

More specifically, FIG. 7 is a sectional view of the linear motion device 1 along a plane passing through the axis LB of the output member 7 and perpendicular to the rotation axis LA. In FIG. 8, the section of the linear motion device 1 along the line VIIIa-VIIIa in FIG. 7 is shown on the output member 7 side with respect to the dashed line L1. In FIG. 8, the section of the linear motion device 1 along the line VIIIb-VIIIb in FIG. 7 is shown on the drive unit 2 side with respect to the dashed line L1.

According to the fourth modification example, the linear motion mechanism 5 has a rack 58 and a pinion 59. The rack 58 is a member shaped like a rod and having teeth 58a. The teeth 58a are provided on the side surface of the rack 58 and are arranged next to each other in the direction in which the rack extends. According to the fourth modification example, the rack 58 extends in the direction in which the axis LB of the output member 7 extends. The pinion 59 is shaped like a common circular gear. The teeth 58a of the rack 58 mesh with the teeth 59a of the pinion 59. Therefore, upon rotation of the pinion 59, the rack 58 is driven. As a result, the relative positions of the rack 58 and pinion 59 change. In other words, the linear motion mechanism 5 has a rack and pinion mechanism.

According to the fourth modification example, the pinion 59 serves as the rotating portion 51, which can rotate upon input of rotation from the drive unit 2. The pinion 59 is fixed onto the end of the second member 42 that faces the first side SA1 in the axial direction DA. According to the fourth modification example, the rack 58 serves as the linear motion portion 52, which can move linearly when driven by the rotational motion of the rotating portion 51. According to the fourth modification example, the rotational motion is output from the drive unit 2 and input into the pinion 59, thereby causing the pinion 59 to rotate in the circumferential direction DB. Upon the rotation of the pinion 59, the rotational motion of the pinion 59 drives the rack 58. The rack 58 linearly moves in the direction in which the rack 58 extends. In this manner, the linear motion mechanism 5 relating to the fourth modification example can receive the rotational motion input from the drive unit 2 and convert the rotational motion into linear motion.

According to the fourth modification example, the rack 58 serving as the linear motion portion 52 may move linearly on the line that does not coincide with the rotation axis LA of the rotation output from the drive unit 2. According to the fourth modification example, the rack 58 linearly moves in the direction orthogonal to the axial direction DA, in which the rotation axis LA extends. According to the fourth modification example, the rack 58 is a coaxial with the axis LB of the output member 7 and linearly moves on the axis LB.

The foregoing embodiment disclosed herein describes a plurality of physically separate constituent parts. They may be combined into a single part, and any one of them may be divided into a plurality of physically separate constituent parts. Irrespective of whether or not the constituent parts are integrated, they are acceptable as long as they are configured to attain the object of the invention.

Aspects of the invention are not limited to the foregoing embodiment and embrace various modifications conceivable by those skilled in the art. Advantageous effects of the invention are also not limited to those described above. In other words, various additions, modifications, and partial deletions are possible in a range not departing from the conceptual ideas and spirit of the present invention derived from contents defined in the claims and the equivalents thereof.

### REFERENCE SINGS LIST

1 linear motion device
2 drive unit
3 electric mechanism
31 rotating shaft
4 speed reducing unit
41 first member
42 second member
43 crankshaft
44 external gear
5 linear motion mechanism
53 ball screw
54 screw shaft
55 nut
56 pressing surface
6 cylinder
65 space
7 output member
81 housing member
82 bearing
83 accumulator
10 conversion mechanism

1. A linear motion device comprising:
a drive unit configured to output rotation;
a linear motion mechanism configured to receive rotational motion input from the drive unit and convert the rotational motion into linear motion;
a cylinder containing a fluid to which the linear motion is input from the linear motion mechanism; and
an output member to which the linear motion input from the linear motion mechanism is transmitted via the fluid.

2. The linear motion device of claim 1, wherein the drive unit includes:
an electric mechanism; and
a speed reducing unit configured to reduce rotation of the electric mechanism and transmit the reduced rotation to the linear motion mechanism.

3. The linear motion device of claim 1, wherein an area of a surface of the linear motion mechanism that is configured to press the fluid is different from that of a surface of the output member that is configured to be pressed by the fluid.

4. The linear motion device of claim 3, wherein the surface of the linear motion mechanism that is configured to press the fluid has a greater area than the surface of the output member that is configured to be pressed by the fluid.

5. The linear motion device of claim 1,
wherein the cylinder is shaped like a tube,
wherein the linear motion mechanism has a surface configured to press the fluid,
wherein the output member has a surface configured to be pressed by the fluid,
wherein the fluid is sealed in a space demarcated by an inner surface of the cylinder, the surface of the linear motion mechanism that is configured to press the fluid, and the surface of the output member that is configured to be pressed by the fluid.

6. The linear motion device of claim 5, further comprising an accumulator including:
a first chamber opening to the inner surface of the cylinder so that the first chamber is in communication with the space; and
a second chamber, a volume of the second chamber being configured to change as a pressure of the first chamber changes to change a volume of the first chamber.

7. The linear motion device of claim 1, further comprising:
a housing member housing at least a rotating portion of the linear motion mechanism, the rotating portion being configured to rotate upon receiving the rotational motion input from the drive unit; and
a bearing in contact with the rotating portion and the housing member such that the rotating portion is rotatable relative to the housing member.

8. The linear motion device of claim 2,
wherein the speed reducing unit includes:
a first member having internal teeth;
a second member rotatable relative to the first member;
a crankshaft rotatably supported on the second member; and
an external gear having a through hole through which the crankshaft passes, the external gear having external teeth meshing with the internal teeth of the first member, and
wherein rotation of the second member is input into the linear motion mechanism.

9. The linear motion device of claim 1, wherein the linear motion mechanism includes
a ball screw having a screw shaft and a nut.

10. A conversion mechanism for converting rotational motion into linear motion, the conversion mechanism comprising:
a linear motion mechanism configured to receive rotational motion input thereto and convert the rotational motion into linear motion;
a cylinder containing a fluid to which the linear motion is input from the linear motion mechanism; and
an output member to which the linear motion input from the linear motion mechanism is transmitted via the fluid.

11. A construction machine comprising:
the linear motion device of claim 1; and
a working portion configured to be driven by the linear motion device to move linearly.

12. A railway brake comprising the linear motion device of claim 1.
